(19) United States
(12) Patent Application Publication
(10) Pub. No.: US 2019/0071285 A1
(43) Pub. Date: Mar. 7, 2019

(54) DRIVE UNIT FOR AN ELEVATOR SYSTEM

(71) Applicants: THYSSENKRUPP ELEVATOR AG, Essen (DE); thyssenkrupp AG, Essen (DE)

(72) Inventors: Thomas KUCZERA, Leinfelden-Echterdingen (DE); Walter HOFFMANN, Niedernhausen (DE); Mike OBERT, Gernsbach (DE)

(73) Assignees: THYSSENKRUPP ELEVATOR AG, Essen (DE); thyssenkrupp AG, Essen (DE)

(21) Appl. No.: 16/091,332

(22) PCT Filed: Mar. 31, 2017
(86) PCT No.: PCT/EP2017/057737

§ 371 Date: Oct. 4, 2018

(30) Foreign Application Priority Data
Apr. 7, 2016 (DE) 10 2016 205 794.4

(51) Int. Cl. B66B 11/04; B66B 11/00; B66B 9/00; B66B 1/36; H02K 7/08; H02K 7/102; H02K 9/19; H02K 11/21; H02K 11/33; H02K 21/22

(52) U.S. Cl. CPC B66B 11/0438; B66B 11/005; B66B 9/003; B66B 1/365; H02K 21/22; H02K 7/102; H02K 9/19; H02K 11/21; H02K 11/33; H02K 7/088

(57) ABSTRACT

A drive unit may be employed by an elevator system with vertical guide rails in two shafts, a horizontal guide rail that connects the vertical guide rails in the two shafts, independently movable elevator cars guided via guide rollers, and a rotatable rail segment configured to be transferred by the drive unit from a vertical alignment into a horizontal alignment so that the elevator cars may be transferred between shafts. The drive unit may include a first interface for at least indirectly fastening the rotatable rail segment to the drive unit, and a second interface for at least indirectly fastening the drive unit to a shaft wall in the first or second elevator shafts.”

### TECHNICAL FIELD

The invention relates to a drive unit for an elevator system and an elevator system comprising such a drive unit.

### TECHNICAL BACKGROUND

So-called multi-elevator systems comprise at least two elevator shafts, wherein in each of the elevator shafts at least one first vertical guide rail is present for the vertical guidance of an elevator car. A plurality of elevator cars is provided, said elevator cars moving independently of one another along the first guide rail in the elevator shaft. The first guide rail comprises at least one rotatable rail segment which is able to be transferred by means of a drive unit from a vertical alignment, in particular, into a horizontal alignment deviating from the vertical alignment, so that an elevator car may be transferred from a first elevator shaft into a second elevator shaft via a second, in particular horizontal, guide rail. The elevator car is guided via guide rollers on the first and the second guide rail.

The rotatable rail segment in this case represents a key component which undertakes the relocation of the elevator car from a vertical direction of travel into a non-vertical, namely oblique o horizontal, direction of travel. Only the paternoster-type design of multi-elevator systems is able to be implemented thereby. For this reason, such a multi-elevator system is disclosed in WO 2015/144781 A1.

The rotatable rail segments are rotated by means of the drive unit discussed here. This drive unit is intended to utilize as far as possible the constructional space which is available. Moreover, the drive unit has to be designed to be reliable. A malfunction of the drive unit would immobilize an entire elevator shaft. Since multi-elevator systems are designed so that the transport capacity of a large high-rise building is intended to be ensured with as few shafts as possible, the malfunction of one elevator shaft has a significant effect on the transport situation of the high-rise building.

Such rotatable rail segments, however, are also conceivable in single-shaft elevator systems. Via the rotatable rail segment, individual elevator cars may be transferred into and/or out of the elevator shaft.

The drive unit discussed here must not be confused with a drive unit used for driving a drive cable of an elevator.

### SUMMARY OF THE INVENTION

It is the object of the present invention to provide a suitable drive unit for driving the rotatable rail segment.

The object underlying the invention is achieved by a drive unit as claimed in claim 1 and an elevator system as claimed in claim 15; preferred embodiments are disclosed in the subclaims and in the following description.

The drive unit according to the invention is suitable for an elevator system which comprises the following: at least one elevator shaft, in particular at least two elevator shafts; at least one first vertical guide rail in each elevator shaft; at least one second non-vertical, in particular horizontal, guide rail, the vertical guide rails in the at least two elevator shafts, in particular, being able to be connected together thereby; a plurality of elevator cars which are movable independently of one another along the first guide rail; at least one rotatable rail segment which is able to be transferred by means of the drive unit from a vertical alignment into an, in particular, horizontal alignment deviating from the vertical alignment, so that the elevator car may be transferred from the first guide rail to the second guide rail. The elevator car may be guided via guide means, in particular guide rollers, sliding guides or magnetic guides on the first and second guide rail.

The drive unit comprises, in particular, a first interface which is designed for at least indirectly fastening the rotatable rail segment to the drive unit and a second interface which is designed for at least indirectly fastening the drive unit in an elevator shaft. As a result, the drive unit is designed to carry the rotatable rail segment together with the elevator car guided thereon. The drive unit is designed to be correspondingly robust.

Thus the essential idea of the invention is to configure the drive unit and the drive function at the same time as a support unit for the rotatable rail segment. A small space requirement is required for such a drive unit since only one bearing unit has to be available both for the retaining structure and the drive structure of the rotatable rail segment.

The drive unit preferably comprises at least two, preferably three, sub-units, in particular a bearing unit, an electric motor unit and/or a brake unit, wherein the sub-units are arranged coaxially about a common drive axis. The sub-units are arranged to be radially adjacent to one another and are also arranged to be axially overlapping, in particular in the same axial position.

In particular, in this case, coils of the electric motor unit are arranged to be radially adjacent and/or axially overlapping with a bearing ring which is fixed in terms of rotation, in particular an outer bearing ring. The coaxial arrangement does not require a rotationally symmetrical shape. Instead, “coaxial” not in this context means that rotatable parts of the sub-units are rotatable about a common axis.

Preferably, in a first configuration the electric motor unit is arranged radially outwardly, the brake unit is arranged radially inwardly and the bearing unit is arranged radially between the brake unit and the electric motor unit. Alternatively, preferably in a second configuration the brake unit is arranged radially outwardly, the bearing unit is arranged radially inwardly and the electric motor unit is arranged radially between the brake unit and the bearing unit.

It has been shown that it is advantageous if the electric motor unit is arranged radially outside the bearing unit. Thus space-saving configurations consisting of coils of very small dimensions may be produced, said coils producing sufficient torque for the drive due to the radially outward position. For the brake unit different configurations are conceivable, either radially inward or radially outward. The radially inward configuration as a whole permits a drive unit with a very small radial extent; however the brake elements have to be dimensioned in a correspondingly robust manner in the radially inward direction, since due to the short lever arm large forces have to be provided radially inwardly. The second configuration with the brake unit radially outward permits the use of cost-effective components (for example a commercially available disk brake caliper from automotive engineering; but it requires a large radial constructional space of the drive unit.

Preferably the drive axis is aligned coaxially with a rotational axis of the rotatable rail segment and/or the drive unit is configured without a gear mechanism. This configuration permits a space-saving and cost-effective construction of the drive unit.

Preferably, an electric motor unit is configured as an external rotor motor, wherein in particular radially external permanent magnets are arranged radially adjacent to radially internal stator coils and/or are arranged to be axially overlapping with one another. In particular in the case of a drive unit without a gear mechanism, the entire torque has to be provided by the motor itself at very low rotational speed (maximum rotational angle/twist angle is generally 90°). The external rotor motors in this case provide a relatively large torque with a relatively small axial constructional space. The rotational speed of the drive unit is, in particular, less than 1 r/sec, in particular less than 0.5 r/sec or less than 0.1 r/sec. In one embodiment, the rotation of the rail segment is 90° in approximately 3 seconds.

Preferably the drive unit comprises a bearing unit, in particular an axial bearing unit, which is designed to bear fully the weight of the elevator car, in particular including the weight of the passengers and also the tilting moment which is produced by rucksack-type or cantilevered mounting.

Preferably, the drive unit comprises a bearing unit with two bearing rings, namely an inner bearing ring and an outer bearing ring, a first of the bearing rings, in particular the inner bearing ring, being part of an interface for fastening a rotary frame to the drive unit and being, in particular, suitable for a screw connection of the rotary frame to the bearing ring.

Alternatively or additionally, a second of the two bearing rings, in particular the outer bearing ring, is directly fastened, in particular screwed, to a base plate of the drive unit and/or this bearing ring is part of an interface for fastening the drive unit to a shaft wall of the elevator shaft. However, the rotatable rail segments are fastened to the rotary frame; and the rotary frame may be configured integrally with the rotatable rail segments.

Preferably, the electric motor unit comprises a plurality of position sensors which in each case may determine a rotational position of the electric motor unit, in particular the rotor position of the electric motor unit. A position sensor is exclusively assigned to each inverter system.

Preferably, an electric motor unit comprises a plurality of stator coils distributed over the periphery, wherein each of the stator coils in each case is connected to one of at least three stand-alone inverter systems. In particular, each inverter system creates the separate three-phase rotary current system thereof. In this regard, 9 polarities are present here. Even in the case of a malfunction of two inverter systems or the associated coils, the drive unit is still always able to be operated as a three-phase rotary current system, albeit with reduced torque. The stator coils may be arranged on a fixed stator plate (also base plate) of the drive unit.

Preferably, an electric motor unit comprises a plurality of stator coils which are distributed over the periphery and which are arranged at a first spacing from one another in the peripheral direction, wherein two adjacent stator coils are arranged at a peripheral position with a a second larger spacing from one another, so that a peripheral gap is formed, wherein supply lines (at least one is sufficient), in particular electrical lines and/or coolant lines and/or brake fluid lines for the drive unit are able to be guided, in particular are guided, in the radial direction through said peripheral gap. The first spacing may comprise a value of 0 and as a result the coils lie against one another. The second spacing in this embodiment, however, is inevitably larger and forms a peripheral gap which is designed for passing through lines. The radial passage permits simple mounting and a space-saving configuration.

Preferably, a base plate of the drive unit, on which, in particular, the coils of the electric motor unit are attached, is provided with two opposing coolant lines arranged adjacent to one another, in particular arranged axially adjacent to stator coils. The cooling using with a circulating cooling system permits greater motor power with at the same time a high level of protection against malfunction; greater motor power in this case may be equated with more rapid and more frequent relocation processes which in turn may mean greater transport capacity of the elevator system. The opposing coolant lines in this case permit a constant mean coolant temperature in the peripheral direction.

Preferably, an electric motor unit comprises a plurality of permanent magnets which are attached to an, in particular, common integral rotor plate. The rotor plate is, in particular, clamped to one of the bearing rings via the first screw connection which also serves for connecting the rotary frame of the bearing unit. The drive force, therefore, may be transmitted directly to the rotary frame; at the same time the rotor remains decoupled from any carrying forces, in particular tilting moments which are transmitted from the rotary frame to the drive unit.

Preferably, the brake unit comprises at least one spring assembly, in particular a plurality of spring assemblies distributed over the periphery, which spring assembly urges the brake unit into a bleed position and which, in particular, is fastened via a bolt to a base plate of the drive unit. In particular, the pretensioning of the spring assembly, in particular each of the spring assemblies, may be individually adjusted via an adjusting means.

The adjusting means may comprise an adjusting cartridge which is U-shaped in cross section and which in each case encloses a spring assembly from one side axially and over the periphery and is rotatably held on a threaded bolt. This results in a coaxial arrangement of the adjusting cartridge, spring assembly and threaded bolt. By rotating the adjusting cartridge on the threaded bolt the axial position is altered relative to the threaded bolt, whereby the spring is tensioned or relaxed. The threaded bolt is screwed to a base plate; in particular the screw connection takes place via the above-mentioned bolt for connecting the spring assembly to the base plate.

The adjusting means are preferably arranged to be open on the elevator car side so as to be accessible. In particular, the rotor plate comprises radially inwardly a circular opening which releases the adjusting means and/or the spring assemblies, provided the brake unit is arranged radially inwardly. Thus easy maintenance, in particular changing the brake linings, is promoted.

Preferably, the brake unit comprises a removable carrier disk which is provided on both sides with brake linings. The carrier disk is, in particular, connected fixedly in terms of rotation to a rotor, in particular the rotor plate, of the electric motor unit, but in particular in an axially displaceable manner. The actuating movements and wear of the brake elements may be compensated by the axial displaceability.

Preferably, the carrier disk is arranged to be radially overlapping with an actuating disk and is designed to subject the carrier disk to a braking force by an axial force. The actuating disk, in particular, is actuated by a fluid and may be spring-loaded. The carrier disk, in particular, carries the brake linings and may be removed as a unit in order to replace the brake linings. Easy servicability is promoted thereby.

Preferably, a brake unit comprises a fluid chamber which is able to be activated and which is defined by a base plate of the drive unit and a membrane piston. The membrane piston acts on an actuating element, in particular the actuating disk. The actuating element, in particular, is the element which applies a normal braking force for the tribological material pairing. The actuating element may be supported on the membrane piston.

Preferably, the membrane piston is fixed by means of a bolt in the fluid chamber. The bolt may be that bolt by which the actuating element, in particular the actuating plate, is axially guided.

Preferably, the brake unit comprises a brake caliper and a brake disk arc cooperating therewith, wherein the brake disk arc, in particular, comprises an angle at center of less than, in particular, a maximum of approximately 180°, and/or wherein the brake disk arc, in particular, is arranged radially outside an electric motor unit and/or wherein the brake disk arc, in particular, is fastened fixedly in terms of rotation to a rotor of the drive unit. Since the drive unit is provided merely for relocating the rotatable rail segment from horizontal into vertical alignment, a rotatability of less than 360° is sufficient. Moreover, the brake only has to assist this partial rotatability, which is possible with a brake disk arc which is not fully closed in the annular direction. Weight and costs may therefore be saved. At the same time, the brake disk arc may also be freely arranged, radially outwardly, at a suitable peripheral position.

Preferably, an axial length of the drive unit is a maximum of 100 mm.

The elevator system according to the invention comprises at least one elevator shaft, preferably at least two elevator shafts. At least one first vertical guide rail and at least one second, in particular horizontal, guide rail are arranged in each elevator shaft. The vertical guide rails in the at least two different elevator shafts are able to be connected together by the second guide rail. A plurality of elevator cars is provided, said elevator cars being able to be moved independently of one another along the first guide rail. A rotatable rail segment is provided, said rail segment being able to be transferred by means of a drive unit of the type mentioned above, from a vertical alignment into an, in particular, horizontal alignment deviating from the vertical alignment. The elevator car may be transferred from a first elevator shaft via the second guide rail into the second elevator shaft. The elevator car is guided via guide means on the first and second guide rail. According to the invention, the drive unit is arranged inside the elevator shaft in an intermediate space between a shaft wall of the elevator shaft and the elevator car.

By the arrangement in the intermediate space the drive unit may be accommodated in a space-saving manner. A separate machinery compartment is not required. Moreover, it is possible to configure the drive unit to be without a gear mechanism, whereby in turn constructional space and costs may be saved. In principle, “shaft wall” is understood, in particular, as the shaft wall which is arranged on the side of the guide rails which is remote from the elevator car. In other words, the guide rails are arranged between the drive unit and the elevator car. In particular, the guide rails are fastened to this shaft wall.

Further preferably, the intermediate space in which the drive unit is arranged is located axially between the shaft wall and the rotatable rail segment. The required constructional space may be significantly optimized further thereby.

Preferably, the drive unit and those guide rollers which engage to the rear of the guide rail on the side remote from the elevator car (i.e. in particular the side facing the drive unit and/or the shaft wall) are arranged to be axially overlapping with one another. These guide rollers are also denoted hereinafter as the rear-engaging guide rollers. These rear-engaging guide rollers already require a certain amount of constructional space on the rear face of the guide rails which corresponds to the intermediate space within the meaning of this application. Since this intermediate space is also used at the same time for receiving the drive unit, a further increase in constructional space may be avoided by the drive unit.

In one possible embodiment, observed in front view, the drive unit is arranged inside a polygon which is spanned by the rear-engaging guide rollers; in other words this means that the drive unit and the guide rollers do not radially overlap.

In one possible embodiment, the drive unit comprises a region with which the rear-engaging guide rollers are arranged to overlap radially. This may, in particular, be a region of short axial length, so that the guide rollers and drive unit, as it were, share a specific radial constructional space.

In one embodiment, the drive unit in particular comprises L-shaped receiving recesses into which the rear-engaging guide rollers axially protrude. In this case, a first region of the drive unit may be formed so as not to be configured to be radially overlapping with the guide rollers; a second drive unit, however, may be configured to be radially overlapping with the rear-engaging guide rollers (but not axially overlapping).

Preferably, the drive unit comprises a bearing unit with two bearing rings, namely an inner bearing ring and an outer bearing ring, wherein a rotary frame, to which the rotatable rail segment is fastened, is screwed directly to one of the bearing rings, in particular the inner bearing ring and/or wherein another of the two bearing rings, in particular the outer bearing ring, is directly screwed to a base plate of the drive unit and/or is directly screwed to a shaft wall of the elevator shaft. By this type of fastening, the weight of the elevator car together with the tilting moment produced by the rucksack-type or cantilevered mounting, may be introduced as directly as possible into the shaft wall. In this case, only a very few components of the drive unit have to be designed to be robust in order to be able to bear the weight and the tilting moments of the elevator car.

Preferably, the drive unit and, in particular, the rotary frame, is arranged, in particular, at least partially, preferably entirely, in a horizontal recess in the shaft wall. In turn, the spacing of the guide rails from the shaft wall, therefore, may be configured to be very small. This is significant since via the guide rails large tilting moments are introduced into the shaft wall, due to the rucksack-type or cantilevered mounting. The smaller the spacing of the guide rails from the shaft, the smaller the tilting moments. Additionally, as little as possible unused intermediate space is present. The drive unit is designed, in particular, to carry out a rotation of less than 360°. Limiting means are provided. As a result, the wiring of the rails may take place in a brushless manner. More rotation is also not required.

The term “elevator shaft” is to be understood here very broadly and substantially denotes a vertically extending region of a building which is kept free and in which an elevator car may be moved vertically. An elevator shaft does not necessarily have to be defined by four walls. In particular, two adjacent elevator shafts may be arranged adjacent to one another without an intermediate wall.

The drive unit in this case not only provides a drive force; the drive unit in this case is also a support element which, during the relocation process, transmits the entire weight force of the cage in the direction of the building. Since the cage within the scope of the present invention is suspended, in particular, in the manner of rucksack-type or cantilevered mounting, this cage is fastened to the drive unit so as to be cantilevered; and the bending stresses on the drive unit are correspondingly high.

The drive unit according to the invention is not to be confused with so-called pancake drives (for example EP 2 325 983 A1, DE 199 06 727 C1). Pancake drives are very flat drive motors for cable drives which are arranged flat, adjacent to the elevator cage in the shaft. These drives provide a large drive force; but a cage which is arranged in a cantilevered manner is not able to be supported by these drives.

### BRIEF DESCRIPTION OF THE DRAWINGS

The invention is described in more detail hereinafter with reference to the figures, in which:

FIG. 1 shows a first arrangement for relocating an elevator car from one elevator shaft into another elevator shaft in an elevator system according to the invention
a) in front view (y-direction),
b) in side view (x-direction);

FIG. 2 shows a second arrangement for relocating an elevator car from one elevator shaft into another elevator shaft in an elevator system according to the invention
a) in front view (y-direction),
b) in side view (x-direction);

FIG. 3 shows a drive unit for use in an elevator system according to the invention in a partially sectional perspective view;

FIG. 4 shows the drive unit according to FIG. 4 in a sectional plan view;

FIG. 5 shows the drive unit according to FIG. 4 in a sectional side view;

FIG. 6 shows the drive unit according to FIG. 4 in a different partially sectional perspective view;

FIG. 7 shows a brake unit of the drive unit according to FIG. 3 in cross section;

FIG. 8 shows a further cross section of the drive unit according to FIG. 3;

FIG. 9 shows a modification of the drive unit according to FIG. 3
a) in front view
b) in side view;

FIG. 10 shows a modification of the drive unit according to FIG. 9
a) in front view,
b) in side view;

FIG. 11 shows three variants of the attachment of a drive arrangement according to any one of the above figures on a shaft wall.

DESCRIPTION OF THE PREFERRED EMBODIMENTS

FIG. 1a shows a first arrangement for relocating an elevator car 3 from a first elevator shaft into a second elevator shaft in an elevator system 1 according to the invention. The elevator system 1 comprises a plurality of elevator cars 3, only one thereof being shown here. The elevator cars 3 are movable in a plurality of elevator shafts 2.

During the vertical movement, the elevator car 3 is guided by means of first vertical guide rails 4. The vertical guide rail 4 comprises fixed vertical rail segments 6 which are rigidly fastened to a shaft wall 14 of the elevator shaft 2. Moreover, the vertical guide rails 4 comprise rotatable rail segments 5 provided these are located in a vertical alignment, as is shown in FIG. 1 by solid lines. Guide rollers 12 roll on the rail segments 5, 6. The guide rollers 12 are fastened to a frame 16 which is able to move along the rails 4, 8. Via a rotary joint 9 the elevator car 3 is fastened to the frame 16. The rotary joint 9 provides a substantially fixed connection between the elevator car 3 and the frame 16; a rotatability is only provided in order to allow the elevator car 3, during the rotation of the frame, to remain in its original rotational position during the relocation process.

The rotatable rail segments 5 are rotatable between the vertical alignment and a horizontal alignment, shown in dashed lines in FIG. 1. In a horizontal alignment, the rotatable rail segments 5 are a component of horizontal guide rails 8 which also comprise fixed horizontal rail segments 7. Via the horizontal guide rail 8, the elevator car 3 guided by the guide rollers 12 may now pass from the first elevator shaft 2′ into the adjacent elevator shaft (only indicated by the arrow 2″).

The elevator car 3 is guided by means of rucksack-type or cantilevered mounting on the guide rails 4, 8; this means that the guide rails 4, 8 are arranged as a whole on a common side of the elevator car; this is required so that during the horizontal relocation of the elevator car the vertical guide rails 4 do not block the horizontal movement path thereof.

This aforementioned relocation concept is substantially described in the published patent application of the Applicant WO 2015/114781 A1 and the as yet unpublished German patent application 102015218025.5, the contents thereof being incorporated herein by way of reference.

The rotatable rail segments 5 are fastened to a rotary frame 13 which is rotatably fastened to the shaft wall 14. The rotary frame 13 may be configured integrally or in multiple parts with the rotatable rail segments 5. FIG. 1b shows the rotary frame 13 with solid lines in vertical alignment and with dashed lines in horizontal alignment. The rotary frame 13 in turn is rotatably driven by a drive unit 20 in order to alter the alignment of the rotatable rail segments 5 and/or the rotary frame 13.

In principle, the space requirement required by the elevator system 1 is of considerable importance. From FIG. 1a, now the arrangement of the drive unit 20 in the elevator shaft is visible. The drive unit 20 is arranged in an intermediate space 15 between the elevator car 3 and the shaft wall 2. The rotational axes A of the drive unit 20 and the rotatable rail segments 5 driven thereby are arranged coaxially to one another. In this respect, the drive unit 20 is without a gear mechanism. It is visible that in principle this intermediate space 15 is intended to be of small dimensions in order to avoid unnecessary surface usage. The drive unit 20 has to be designed such that it may be accommodated in the intermediate space 15, which is already present in any case due to other parameters. An increase in the area of the intermediate space 15 simply for the drive arrangement to have additional space here must be avoided.

The drive unit 20 comprises an electric motor unit 40 which is described in more detail in the following figures. This electric motor unit 40 is configured as an external rotor motor which permits a relatively flat (axially small) construction but nevertheless with a large torque.

The drive unit 20 is arranged in an intermediate space 15 which is axially arranged between the rotatable rail segments 5 and the shaft wall 14. This shaft wall 14 is the shaft wall which is arranged closest to the rails and to which the fixed vertical rail segments 6 and the drive unit 20 itself are fastened.

The drive unit 20 has to be arranged in this case such that the drive unit 20 does not hinder the movement of the guide rollers 12. In particular, this relates to those guide rollers 12* which, viewed from the elevator car 3, engage to the rear of the guide rails 4, 8 (hereinafter the “rear-engaging guide rollers”). These are those guide rollers 12* which are arranged closest to the shaft wall 14 and are arranged on one side of the rails which are remote from the elevator car. In the embodiment of FIG. 1 the spacing of the guide rollers 12 from the rotational axis A is greater than the radial extent of the drive unit 20 (measured from the rotational axis). Additionally, the rear-engaging guide rollers 12* are arranged spaced widely apart from one another such that they form a rectangle which is substantially congruent with the positions of the rotatable rail segments 5 in the vertical and horizontal position thereof. The drive unit 20 in this case is arranged inside a radial region 21 which is located entirely inside this rectangle so that a collision of the drive unit with the rear-engaging guide rollers 12* is excluded. By this arrangement it is possible that the radial region inside the guide rollers 12 may be optimally used for receiving the drive unit 20. The drive unit 20 and the rear-engaging guide rollers 12* in this case are arranged to be axially overlapping with one another.

FIG. 2 shows an alternative embodiment which corresponds substantially to the embodiment according to FIG. 1 and reference is made to the description thereof. Hereinafter, only the differences therefrom are described in detail. The drive unit 20 comprises a first region 21 which is arranged in a similar manner to the embodiment according to FIG. 1, radially inside the rectangle which is spanned by the rear-engaging guide rollers 12* and is arranged to be axially overlapping with these rear-engaging guide rollers. The drive unit 2 further comprises a second region 22 which is arranged axially adjacent to the rear-engaging guide rollers 12* and is arranged to be radially overlapping with rear-engaging guide rollers 12*. In this region the drive unit forms an L-shaped recess 23 into which the rear-engaging guide rollers 12* protrude. This arrangement requires a larger axial constructional space than the arrangement according to FIG. 1, but constitutes an alternative if the drive unit 20 has to be dimensioned to be so large that the arrangement according to FIG. 1 is not possible. Due to the constructional space requirement of the second region 22, the intermediate space 15 is thus larger than in FIG. 1.

Further parts of the drive unit 20 may be arranged in a manner similar to FIG. 1 in the first region 21. Only those parts of the drive unit 20 for which there is no room here are arranged in the second region 22. Since at least the first region 21 is arranged to be axially overlapping with the rear-engaging guide rollers 12*, the additional axial constructional space requirement is kept within limits. For example, magnetic components of rotors and stators of the electric motor may be arranged in the second region 22. As these magnetic components are located further radially outwardly, in comparison with FIG. 1, a comparably large torque may be produced by identical components or an identical torque may be produced by comparably small magnetic components. Moreover, a brake unit may be arranged radially outwardly, said brake unit producing a relatively high braking moment due to the radially outward position. Further details of a possible relocation are described below with reference to FIG. 10.

In principle, the following embodiments apply as far as possible to both variants of FIGS. 1 and 2.

The rotary frame 13 is fixedly connected via first screw connections 17 rigidly to the drive unit 20. The drive unit 20 in turn is fixedly connected via second screw connections 18 to the shaft wall 14. Via the rotary frame 13, the first screw connections 17, the drive unit 20 and finally the second screw connections 18, the entire weight of the elevator car 3, including the tilting moments present due to the rucksack-type or cantilevered mounting, is introduced into the shaft wall 14. The entire arrangement around the drive unit 20 has to be designed to be correspondingly robust. A conventional flat drive motor (so-called pancake design) for driving cable-operated elevator cages is, in particular, not designed for this tilting moment load. Alternatively, the second screw connection of the outer bearing ring 32 may be directly screwed to the shaft wall.

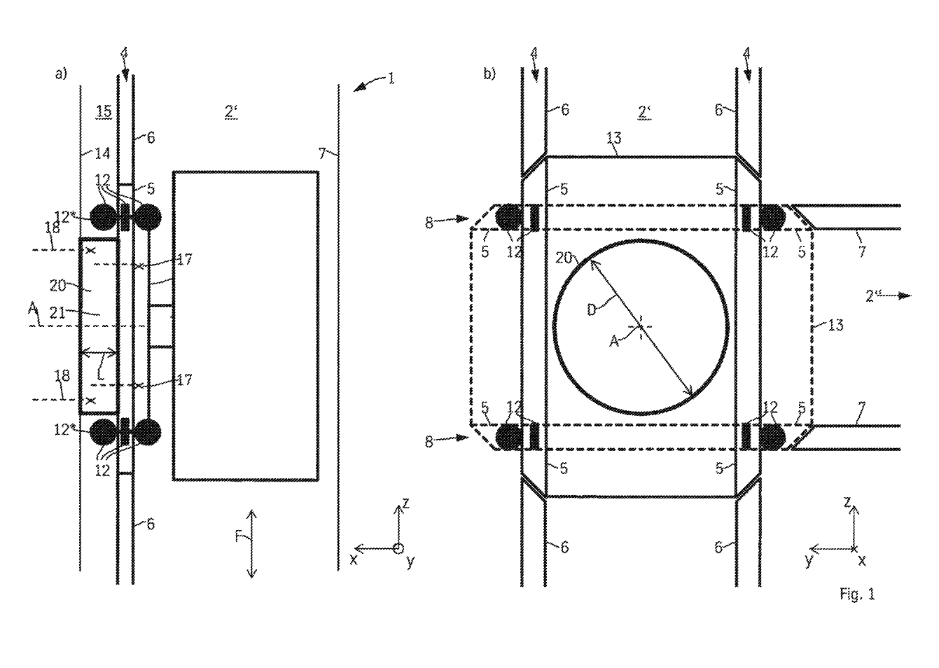

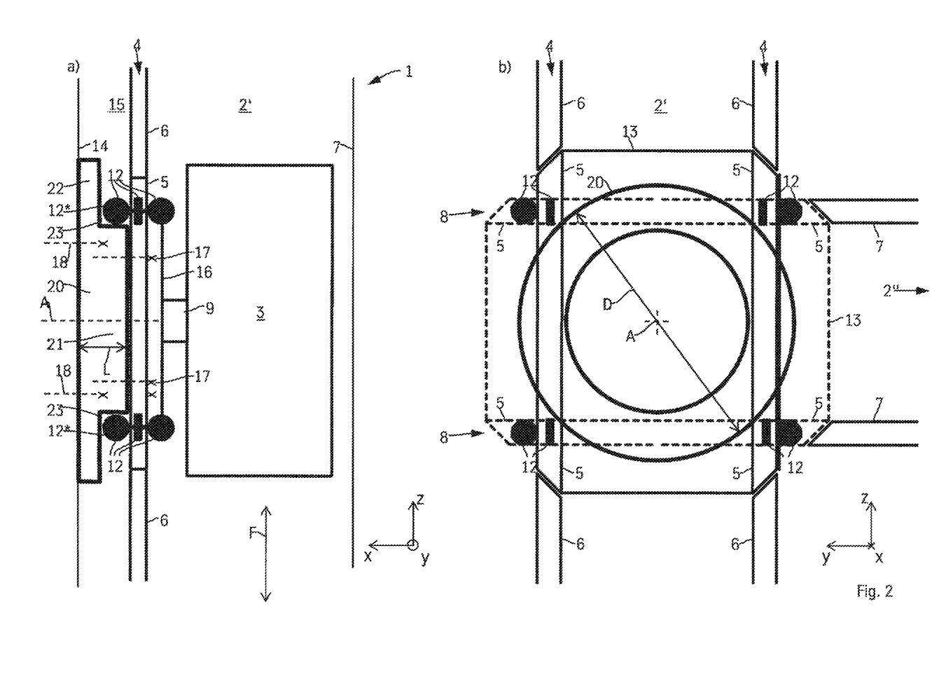

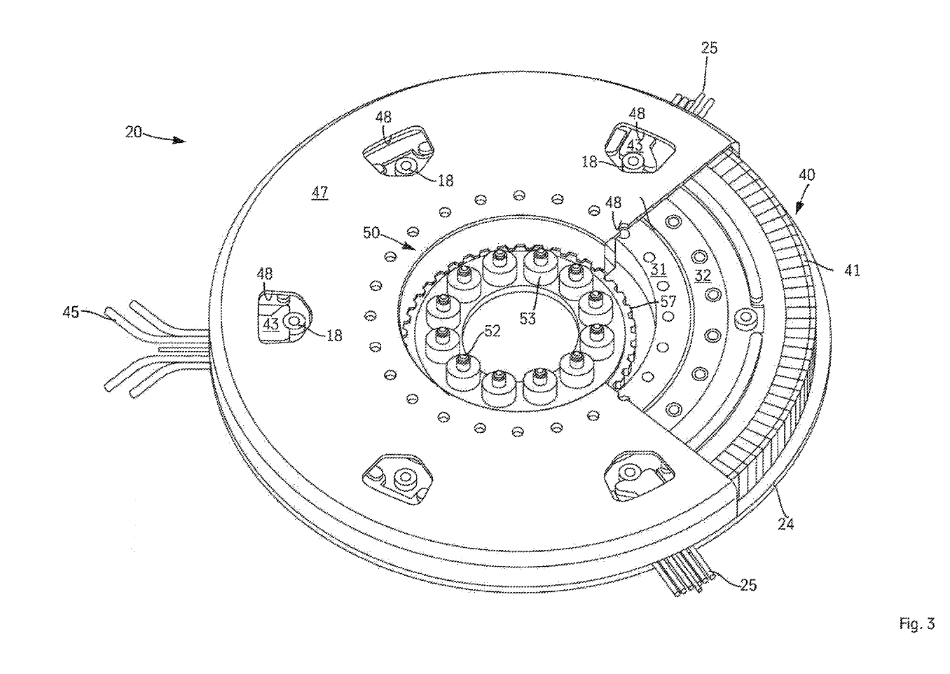

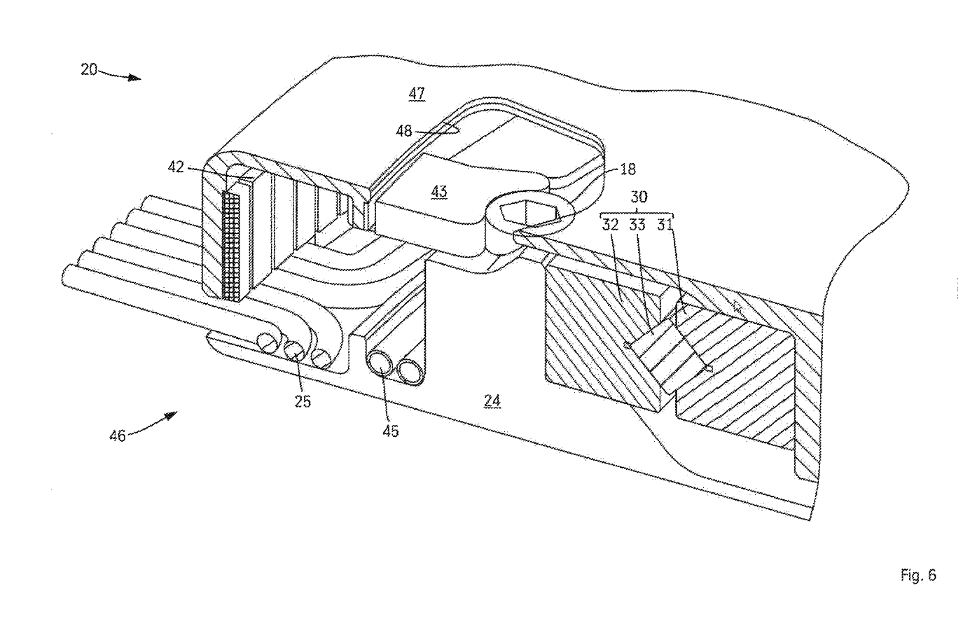

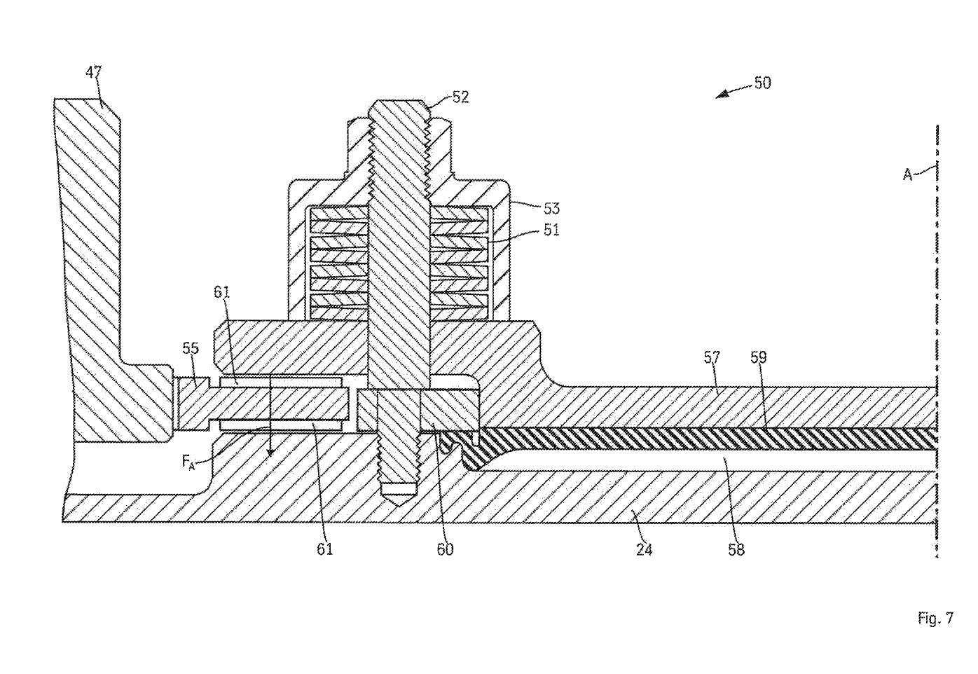

In FIGS. 3 to 8 an exemplary embodiment of a drive unit 20 which corresponds to the variant of FIG. 1 is shown in more detail; by minimal alterations this may also be applied to the variant of FIG. 2. FIGS. 3 to 8 are described together hereinafter; reference is always made to the most relevant figure in parenthesis.

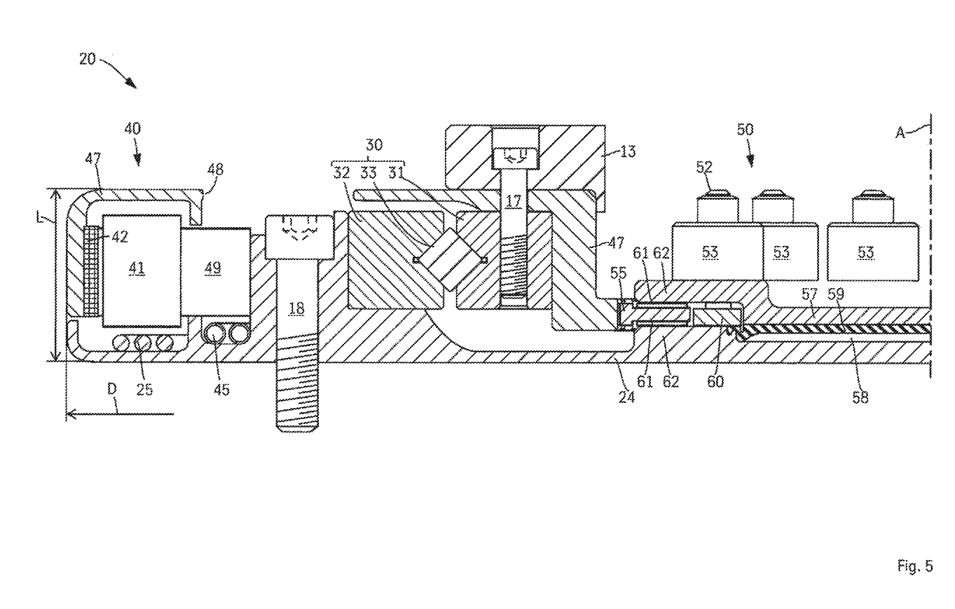

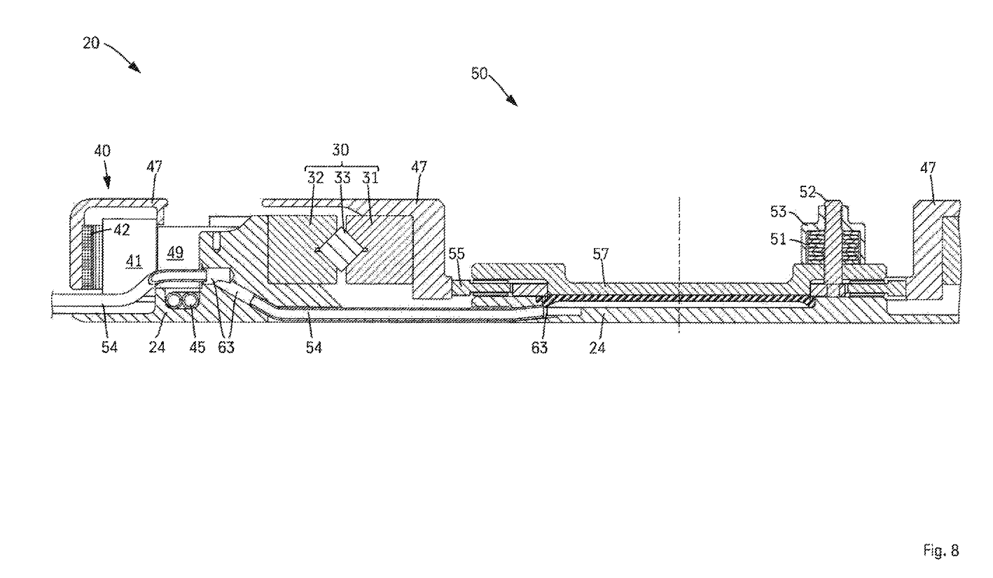

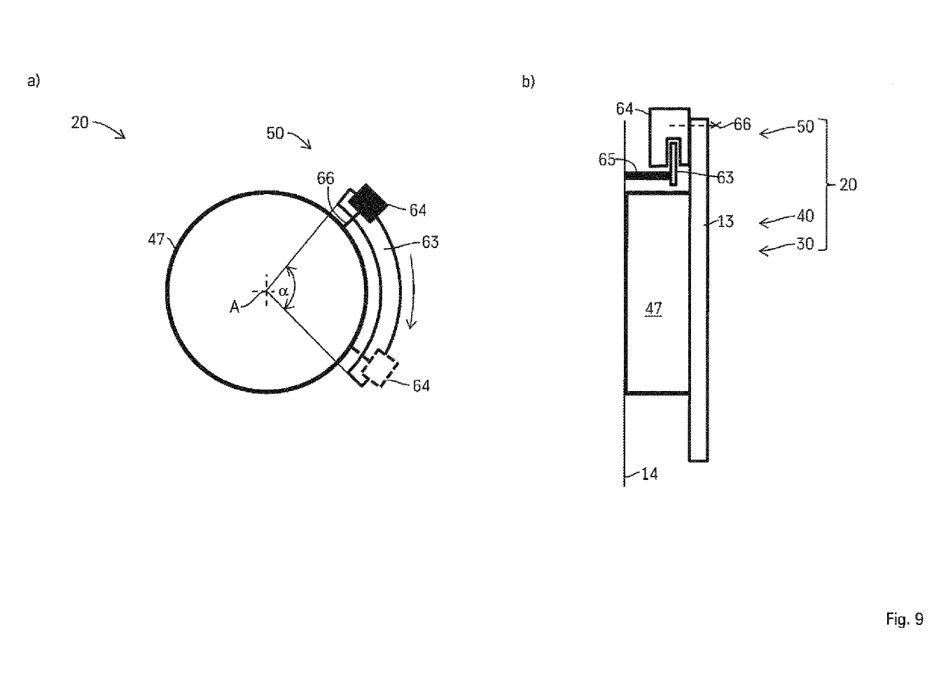

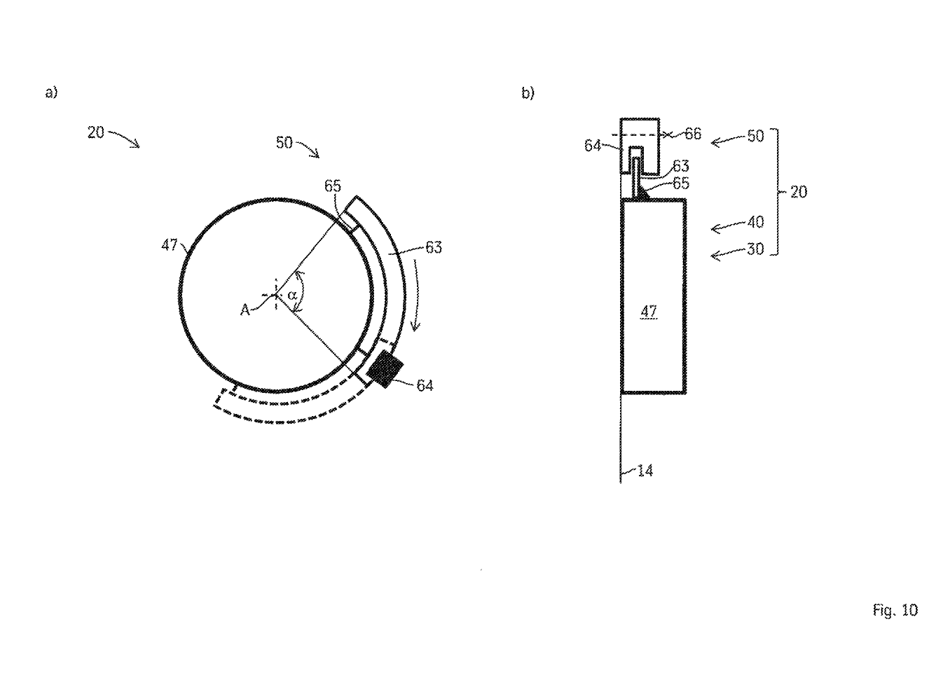

The drive unit 20 comprises an electric motor unit 40, a bearing unit 30 and a brake unit 50 (FIGS. 5 and 8). In the present exemplary embodiment, the electric motor unit is arranged radially outwardly and the brake unit 50 is arranged radially inwardly. The bearing unit 30 is arranged radially between the electric motor unit 40 and the brake unit 50.

The bearing unit 30 comprises an inner bearing ring 31, an outer bearing ring 32 and rolling bodies 33 rolling between the inner and outer ring (FIG. 5). In the present case, the rolling bodies 33 are configured as cylinder rollers which are arranged in cross-roller guidance between the bearing rings 31, 32. By a selected arrangement of the rolling bodies 33, the cross-roller guidance permits the bearing unit 30 to be configured to be stronger in the loading direction, vertically downwardly, than in the horizontal loading direction. The rotary frame 13 is screwed via the first screw connections 17 to the inner bearing ring; the outer bearing ring 32 is fastened to a base plate 24 which is fastened to the shaft wall 14 via second screw connections 18.

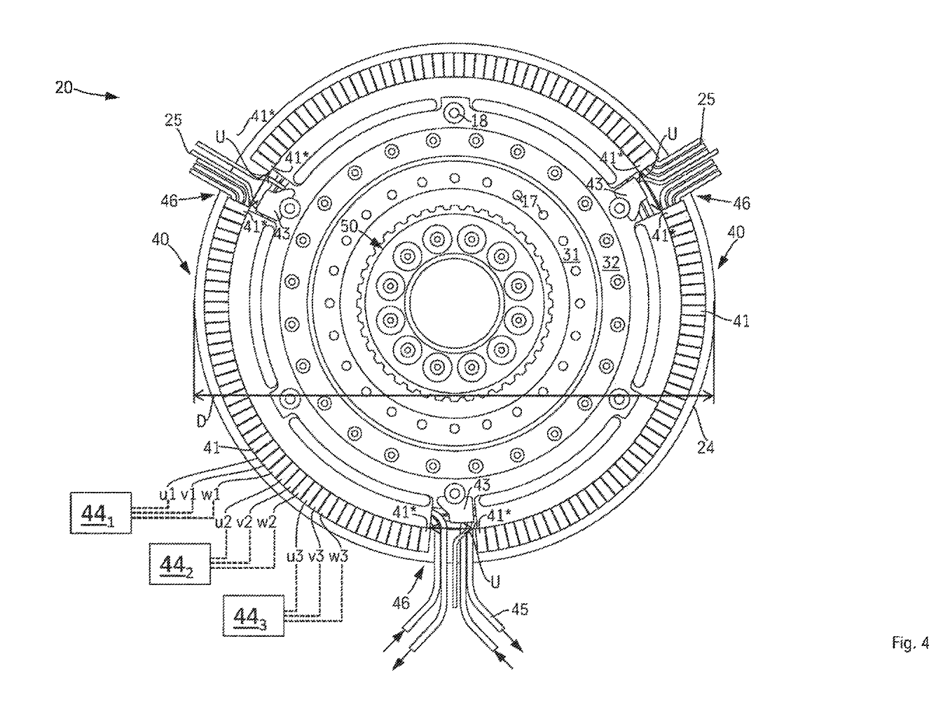

The electric motor unit 40 comprises a plurality of stator coils 41 which are distributed over the periphery and which are fastened to the base plate 24 (FIGS. 4 and 5). The stator coils 41 cooperate with a plurality of permanent magnets 42 which are distributed over the periphery and which are fastened to a rotor plate 47. The rotor plate 47 is held rotatably relative to the base plate 24. In the present case, the rotor plate is screwed to the inner bearing ring 31, in this case via the first screw connections 17. The stator coils 41 and the permanent magnets 42 are arranged radially adjacent to one another; as a result, the rotor magnets are arranged radially outside the stator magnets which promotes a short axial construction. Additionally, the torque produced by the electric motor unit is increased thereby.

Position sensors 43 are fixedly arranged on the base plate 24 so as to be distributed over the periphery. Access is provided to the position sensors 43 from the direction of the interior of the elevator shaft 2 through recesses 48 in the rotor plate 47. The sensors 43, therefore, may be replaced or adjusted without the rotor plate 47 having to be removed. Sensor strips, not shown, which are fastened to the rotor plate 47 serve as signal transmitters for the position sensors 43 (FIGS. 3 to 5). At the same time, the openings permit access to the screws of the second screw connection 18 in order to mount and/or dismantle the drive unit 20 as a unit on the shaft wall 14 (FIGS. 3 to 6).

The electric motor unit 40 is cooled via a cooling system. The cooling system comprises coolant lines 45 which are arranged in an annular manner on the base plate 24, radially overlapping with iron cores 49 which are assigned to the stator coils 41 (FIGS. 5, 6 and 8). In this case two separate coolant lines 45 which are arranged adjacent to one another are provided, coolant fluid flowing in different directions through said coolant lines. Coolant flows in a clockwise direction through a first radially outwardly located coolant line 45; and coolant flows in a counterclockwise direction through a second radially inwardly located coolant line. The coolant on its annular path through the electric motor units absorbs heat and thus is heated continuously. By the opposing flow directions it is achieved that the average temperature of the coolant fluid in the two lines is approximately at the same level in each peripheral position. A uniform cooling of all stator coils is thus ensured (FIG. 4).

The electric motor unit 40 comprises three separately configured three-phase motors. All of the stator coils 41 are arranged adjacent to one another in the peripheral direction. The stator coils 41 arranged adjacent to one another, however, are interconnected with separate inverters 44₁, 44₂ and 44₃. In the case of malfunction of one inverter 44, therefore, the stator coils 41 assigned to another inverter are able to maintain operation. FIG. 4 shows the arrangement and interconnection of the stator coils here. The stator coils with the polarity u1, v1, w1 of the first electric motor are arranged adjacent to one another in the peripheral direction. Three starter coils with the polarity u2, v2, w2 of the second electric motor and subsequently the further stator coils with the polarity u3, v3, w3 of the third electric motor adjoin one another. In turn, further stator coils with the polarity u1, v1, w1 (not illustrated) of the first electric motor adjoin one another, etc. Even in the case of malfunction of two electric motors, an entire electric motor remains spare in order to maintain at least emergency operation. Since in such a case only ⅓ of all stator coils 41 are able to produce torque, the operation of the relocation unit is correspondingly retarded but it may nevertheless be maintained.

In FIG. 4 it may also be seen that at three peripheral positions peripheral gaps 46 are provided between two stator coils 41 which are adjacent in the peripheral direction. The peripheral gap 46 has a spacing U in the peripheral direction of approximately 10-20 mm. Through this peripheral gap 46 supply lines, in particular the electrical lines 25 and/or the coolant lines 45, are guided radially through the ring consisting of stator coils 41. This permits the supply lines to be able to be guided radially into the drive unit and/or out of said drive unit 20. This promotes a space-saving layout of the lines 25, 45 and additionally permits simple mounting. However, guiding the supply line into the shaft wall would involve costly mounting of the drive unit on the shaft wall, since the lines have to be laid directly in their end position at the same time as the drive unit is guided and fastened onto the shaft wall. Due to the rotating rotor, it is virtually eliminated that the supply lines are guided axially in the direction of the elevator shaft and thus in the direction of the elevator car.

The brake unit 50 comprises a carrier disk 55 which is connected fixedly in terms of rotation via a toothing to the rotor plate 47. The toothing in this case permits an axial mobility of the carrier disk 55 relative to the rotor plate 47. The carrier disk 55 in each case bears a brake lining 61 on both axial sides. During braking, this brake lining 61 is clamped between two opposing brake disks 62, a first brake disk thereof being integrally configured with the base plate 24 and a second brake disk thereof being formed by an axially actuatable and axially movable actuating disk 57 (FIGS. 5, 7 and 8). The exact construction of this brake unit may be identified, in particular, from FIG. 7. The actuating disk 47 is actuated hydraulically or pneumatically. In this case, a fluid chamber 58 is formed between the actuating disk 57 and the base plate 24, said fluid chamber being sealed by a membrane piston 59. The membrane piston 59 lies against the actuating disk 57. If a fluid pressure is produced at a specific level in the fluid chamber 58, the membrane piston 59 acts axially on the actuating disk 57.

The actuating disk 57 is pretensioned by a spring assembly 51 which acts on the actuating disk 57 in the direction of the base plate 24 and thus in principle acts thereon into the closed position of the brake. The fluid pressure in the fluid chamber 58 thus serves for opening the brake and/or acts counter to a closing of the brake. The pretensioning of the spring assembly 51 is adjusted by a plurality of adjusting cartridges 53 distributed over the periphery. The individual cartridge 53 is rotatably screwed to a connecting bolt 52 with a thread. Depending on the rotational position and the direction of travel on the thread of the connecting bolt 52, the relative axial position of the adjusting cartridge 53 is adjusted relative to the actuating disk 57. As a result, the spring assembly 51 which is received inside the adjusting cartridge 53 is compressed and thus pretensioned.

By means of the connecting bolt 52, the membrane piston 59 is also fastened to the base plate. To this end, a membrane fixing flange 60 which is configured to circulate in an annular manner is provided. The membrane fixing flange 60 clamps the membrane piston 59 axially to a radially outwardly located fastening region of the base plate 24. The connecting bolt 52 thus serves for fastening the spring assembly 51, the adjusting of the pretensioning of the spring assembly 51 and the fastening of the membrane fixing flange 60 to the base plate 24.

For changing the brake linings 61 initially the individual cartridges 53 have to be unscrewed. Then the spring assemblies 51 may be removed and the actuating disk 57 is released. This actuating disk 57 may now be axially removed by being guided on the connecting bolt 52. Now the carrier disk 55 is released. By means of the toothing, the carrier disk 55 may be removed from the rotor plate 47 without the rotor plate 47 having to be released. Then the carrier disk may be provided with new brake linings 61 or a new carrier disk is provided with new, premounted brake linings 61. Then the carrier disk 55 is brought into toothed engagement with the rotor plate 47. Then the actuating disk 57 is guided onto the connecting bolt 52 and subsequently the spring assemblies 51 and the adjusting cartridges 53 are mounted. Then the pretensioning of the spring assemblies is undertaken by adjusting the respective rotational positions of the individual cartridges 53.

The brake fluid is conducted into the fluid chamber 58 via a brake fluid line 54. The brake fluid line 54 is also radially introduced through the peripheral gap 46 into the drive unit 20. The brake fluid line 54 is partially formed by bores 56 in the base plate 24.

The diameter D of the drive unit 20 is 800 mm (FIGS. 1, 2 and 5). The axial length L of the drive unit 20 is 150 mm (FIGS. 1, 2 and 5). The directional information “axial” and “radial” refers in principle to the rotational axis A of the drive unit 20 provided nothing different is specified.

A modification of the drive unit 20 according to FIGS. 3 to 8 is shown in FIG. 9, which substantially corresponds to the embodiment according to FIGS. 3 to 8; in this regard reference is made to the corresponding description. Hereinafter only the differences are described in detail.

The brake unit 50 is arranged radially outside the rotor plate 47 of the electric motor unit 40. Via a fastening 66 a brake caliper 64 is connected at least fixedly in terms of rotation to the rotor plate 47. The fastening may be carried out by the brake caliper 64 being screwed to the rotary frame 13 (FIG. 9c). The rotary frame 13 in turn is fixedly connected to the rotor plate 47. The brake caliper 64 cooperates with a brake disk arc 63. Since the rotatable rail segment 5 (FIGS. 1 and 2) only has to be transferred from the vertical alignment to the horizontal alignment, a rotatability of the rotary frame 13 and/or the rotor plate 47 of merely 90° is required. Equally for the brake disk arc 63 a geometric angle at center a of slightly more than 90°, in the present case approximately 100°, is sufficient.

FIG. 9a shows in this case the brake caliper 64 connected to the rotor plate 47 in the two rotary end positions (one shown in solid lines and one shown in dashed lines).

A modification of the drive unit 20 according to FIG. 9 is shown in FIG. 10 which substantially corresponds to the embodiment according to FIG. 9; in this regard reference is made to the corresponding description. Hereinafter only the differences are described in detail.

The brake caliper 64 is fixedly connected via a screw connection 64 to the shaft wall 14 and held thereby in a stationary manner. The brake disk arc 63 is, for example, fixedly connected via a welded seam 65 to the rotor plate 47. This embodiment is suitable for implementing the concept according to FIG. 2; the radially external second region 22 comprises the brake unit 50. The first region 21 comprises the bearing unit 30 and the electric motor unit 40.

FIG. 10a shows in this case the brake disk arc 63 in the two rotational end positions (one shown in solid lines and one shown in dashed lines).

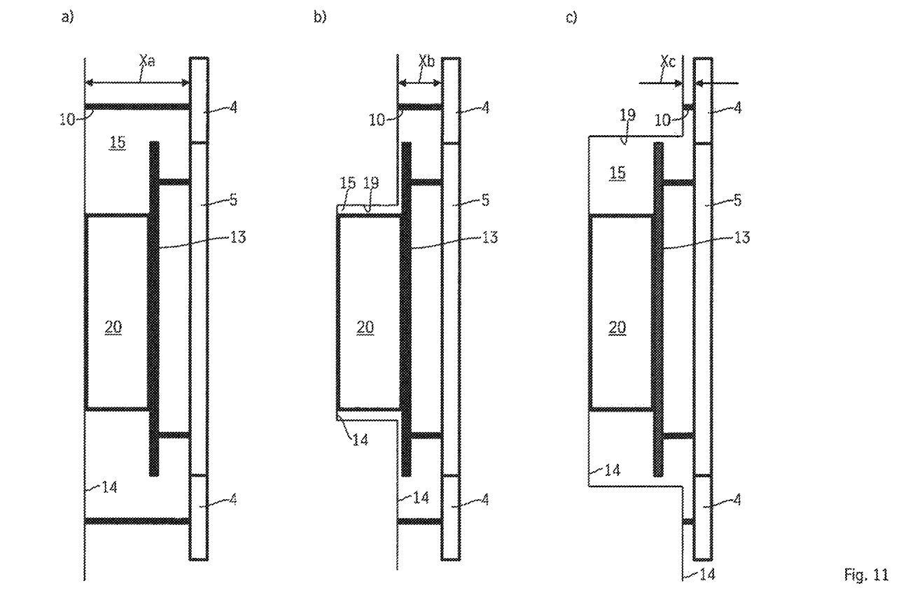

FIG. 11 shows three possibilities for arranging the drive unit in the intermediate space 12. In FIG. 11a, the shaft wall 14 comprises a linear path in side view. The drive unit is arranged on the shaft wall 14; the rotary frame 13 in the axial direction adjoins said shaft wall. The guide rails 4, 5 in the axial direction adjoin the rotary frame 13. Fastening means 10 for fastening the guide rails 4, 5 substantially span the axial length of the drive unit 20 and the rotary frame 13. The axial length of the fastening means here is denoted by Xa. The recess 19 comprises a radial extent which is larger than the radial extent of the drive unit but smaller than the radial extent of the rotary frame 13.

In the variant according to FIG. 11b, the shaft wall 14 comprises a recess 19 in which the drive unit 20 is received. The rotary frame 13 is arranged outside the recess. The fastening means 10 substantially span the axial length of that of the rotary frame 13. The reduced axial length of the fastening means here is denoted by Xb. The recess 19 comprises a radial extent which is larger than the radial extent of the rotary frame 13.

In the variant according to FIG. 11c, the shaft wall 14 comprises a larger recess 19 in which the drive unit 20 and the rotary frame 13 are received. The fastening means 10 here do not have to span any substantial axial spacing. The further axial length of the fastening means is denoted here by Xc.

### LIST OF REFERENCE NUMERALS

1 Elevator system

2 Elevator shaft

3 Elevator car

4 Vertical guide rail

5 Rotatable rail segment

6 Fixed vertical rail segment

7 Fixed horizontal rail segment

8 Horizontal guide rail

9 Rotary joint

10 Fastening means

11

12 Guide roller

13 Rotary frame

14 Shaft wall

15 Intermediate space

16 Frame

17 First screw connection

18 Second screw connection

19 Recess

20 Drive unit

21 First region

22 Second region

23 Receiver recess

24 Base plate

25 Electrical lines

30 Bearing unit

31 Inner bearing ring

32 Outer bearing ring

33 Rolling body

40 Electric motor unit

41 Stator coils

42 Permanent magnets

43 Position sensor

44 Inverter system

45 Coolant line

46 Peripheral gap

47 Rotor plate

48 Recesses

49 Iron core

50 Brake unit

51 Spring assembly

52 Connecting bolt

53 Adjusting cartridge

54 Brake fluid line

55 Carrier disk

56 Bore in base plate

57 Axially actuatable actuating disk

58 Fluid chamber

59 Membrane piston

60 Membrane fixing flange

61 Brake lining

62 Brake disk

63 Brake disk arc

64 Brake caliper

65 Brake disk arc fastening

66 Brake caliper fastening

A Rotational axis

F Direction of travel

F_{A} Axial force

D Diameter

L Axial length

U Spacing of stator coils in peripheral direction in peripheral gap

X Horizontal spacing of fixed guide rail from shaft wall

u1 u-polarity of first inverter system

v1 v-polarity of first inverter system

w1 w-polarity of first inverter system

u2 u-polarity of second inverter system

v2 v-polarity of second inverter system

w2 w-polarity of second inverter system

u3 u-polarity of third inverter system

v3 v-polarity of third inverter system

w3 w-polarity of third inverter system

1-18. (canceled)

19. A drive unit for an elevator system that comprises a first elevator shaft, a second elevator shaft, vertical guide rails in the first and second elevator shafts, a horizontal guide rail configured to connect the vertical guide rails in the first and second elevator shafts, elevator cars that are movable independent of one another along the vertical guide rails, a rotatable rail segment that is configured to be transferred by the drive unit from a vertical alignment into a horizontal alignment so that the elevator cars can be transferred from the vertical guide rails to the horizontal guide rail, the drive unit comprising:
a first interface for at least indirectly fastening the rotatable rail segment to the drive unit; and
a second interface for at least indirectly fastening the drive unit in the first elevator shaft or the second elevator shaft.

20. The drive unit of claim 19 comprising at least two of the following sub-units:
a bearing unit,
an electric motor unit, or
a brake unit,
wherein the at least two sub-units are arranged coaxially about a common drive axis, wherein the at least two sub-units are arranged to be radially adjacent to one another and are arranged to be axially overlapping,
wherein
in a first configuration the electric motor unit is arranged radially outwardly, the brake unit is arranged radially inwardly, and the bearing unit is arranged radially between the brake unit and the electric motor unit, or
in a second configuration the brake unit is arranged radially outwardly, the bearing unit is arranged radially inwardly, and the electric motor is arranged radially between the brake unit and the bearing unit.

21. The drive unit of claim 20 wherein at least one of
the common drive axis is aligned coaxially with a rotational axis of the rotatable rail segment, or
the drive unit is gear mechanism-free.

22. The drive unit of claim 20 wherein the electric motor unit is an external rotor motor, wherein radially external permanent magnets are disposed radially adjacent to radially internal stator coils.

23. The drive unit of claim 19 comprising a bearing unit configured to bear fully a weight of one of the elevator cars.

24. The drive unit of claim 19 comprising a bearing unit with an inner bearing ring and an outer bearing ring, wherein at least one of
the inner bearing ring is part of an interface for fastening a rotary frame to the drive unit and is configured for a screw connection of the rotary frame to the inner bearing ring, or
the outer bearing ring is directly fastened to a base plate of the drive unit and/or is part of an interface for fastening the drive unit to a shaft wall of the first elevator shaft or the second elevator shaft.

25. The drive unit of claim 19 comprising an electric motor unit that includes stator coils distributed over a periphery of the electric motor unit, wherein each of the stator coils is connected to one of at least three stand-alone inverter systems.

26. The drive unit of claim 26 wherein the electric motor unit comprises position sensors, wherein each position sensor determines a rotor position of the electric motor unit, wherein one of the position sensors is exclusively assigned to each of the at least three stand-alone inverter systems.

27. The drive unit of claim 19 comprising an electric motor unit with stator coils that are distributed over a periphery of the electric motor unit and are spaced apart by a first amount in a peripheral direction, wherein two adjacent stator coils are disposed at a peripheral position and are spaced apart by a second amount in the peripheral direction that is larger than the first amount, so that a peripheral gap is formed, wherein supply lines for the drive unit are guided in a radial direction through the peripheral gap.

28. The drive unit of claim 19 comprising a brake unit with a spring assembly that urges the brake unit into a bleed position and is fastened via a bolt to a base plate of the drive unit, wherein pretensioning of the spring assembly is adjustable via an adjusting means.

29. The drive unit of claim 28 wherein the adjusting means are disposed so as to be open and accessible on an elevator side.

30. The drive unit of claim 19 comprising a brake unit that includes a removable carrier disk provided on both sides of the brake unit with brake linings, wherein the removable carrier disk is connected fixedly in terms of rotation to a rotor of an electric motor unit of the drive unit, wherein the removable carrier disk is connected in an axially displaceable manner to the rotor, wherein the removable carrier disk is radially overlapping with an actuating disk such that the removable carrier disk is subjected to a braking force by an axial force.

31. The drive unit of claim 19 comprising a brake unit that includes a fluid chamber that is activatable and is defined by a base plate of the drive unit and a membrane piston fixed by a bolt in the fluid chamber, wherein the membrane piston axially acts on an actuating disk while the bolt axially guides an actuating element.

32. The drive unit of claim 19 comprising a brake unit with a brake caliper that cooperates with a brake disk arc, wherein at least one of
the brake disk arc comprises an angle at center of a maximum of 180°,
the brake disk arc is arranged radially outside an electric motor unit, or
the brake disk arc is fastened fixedly in terms of rotation to a rotor of the drive unit.

33. An elevator system comprising:
a first elevator shaft;
a second elevator shaft;
vertical guide rails in the first and second elevator shafts;
a horizontal guide rail configured to connect the vertical guide rails in the first and second elevator shafts;
elevator cars that are movable independent of one another along the vertical guide rails;
a drive unit that is disposed inside the first elevator shaft or the second elevator shaft in an intermediate space; and
a rotatable rail segment that is configured to be transferred by the drive unit from a vertical alignment into a horizontal alignment so that the elevator cars can be transferred from the vertical guide rails to the horizontal guide rail, wherein the intermediate space where the drive unit is disposed is between a shaft wall and the rotatable rail segment.

34. The elevator system of claim 33 wherein the drive unit and guide rollers, which engage to a rear of the vertical guide rails on a side remote from the elevator cars, are arranged to be axially overlapping with one another.

35. The elevator system of claim 33 wherein, from a front perspective, the drive unit is disposed inside a polygon that is spanned by those guide rollers that engage to the rear of the vertical guide rails on the side remote from the elevator cars.

36. The elevator system of claim 33 wherein the drive unit and a rotary frame are arranged at least partially in a horizontal recess in a shaft wall of the first or second elevator shafts.
